(19) United States
(12) Patent Application Publication
(10) Pub. No.: US 2005/0055718 A1
(43) Pub. Date: Mar. 10, 2005

(54) Peer-to-peer architecture for sharing video on demand content

(76) Inventor: Christopher J. Stone, Newtown, PA (US)

Correspondence Address: Motorola, Inc., 101 Tournament Drive, Horsham, PA, 19044, US

(21) Appl. No.: 10/656,018

(22) Filed: Sep. 5, 2003

(51) Int. Cl. H04N 7/173; H04N 5/445; G06F 13/00

(52) U.S. Cl. 725/61; 725/87; 725/86; 725/105

(57) ABSTRACT

The present invention is a method for providing a peer-to-peer architecture for sharing VOD content. Instead of requiring a large server to store VOD content, VOD content is distributed among one or more content devices. Upon receiving a request to view requested VOD content, an intelligent agent determines which content device contains the requested VOD content. The requested VOD content is then communicated to the requesting content device. Thus, the present invention alleviates the need for a typical content server, and therefore results in a more robust, flexible, and inexpensive network.

### FIELD OF THE INVENTION

The present invention relates to the field of video on demand systems, and more particularly, to a peer-to-peer architecture for sharing video on demand content.

### BACKGROUND OF THE INVENTION

Video on demand (VOD) services provide content to viewers for immediate viewing upon request. While this content typically comprises pre-recorded video content, this content may also include, but is not limited to, live content, audio content, image content, or other types of content yet to be discovered. Hereinafter, those skilled in the art will recognize that the term “VOD content” or “content” may comprise the aforementioned types of content, in addition to video.

In a typical VOD system 100 as illustrated in FIG. 1, software components 116, 118, 120, and 122 (known as VOD clients) reside in a set-top boxes, 102, 104, 106, and 108 respectfully, which are usually located at viewers' homes. A typical VOD system 100 further includes a VOD content server 128, which is a memory intensive system that stores VOD content in the VOD database 114 at the network headend 128. A VOD pump 126, also included within the VOD database, streams the VOD content to the VOD system 100 from the VOD database 114.

In operation, a VOD management system 124, also included within the VOD content server 110, generates a list of available VOD content. The VOD clients 116, 118, 120, and 122 then communicate requests for VOD content to the VOD management system 124 at the network headend 128. In response, the VOD pump 126 transmits the requested VOD content to the requesting content device.

While the typical VOD system functions to provide VOD content to content devices, the typical VOD system is proving to be problematic. Because the memory for storing the VOD content is a finite database 114, the memory requirements of the VOD server cannot increase as the amount of VOD content and VOD customers increase. Thus, to accommodate such demands, new equipment must be added to increase the capabilities of the VOD server. Usually, this equipment is not only expensive, but requires extensive resources to maintain.

Thus, there is a need in the art for an inexpensive method and apparatus for sharing video on demand content. There is also a need for such a method and apparatus that does not require extensive maintenance. Furthermore, there is also a need for such a method and apparatus for storing VOD content that is flexible enough to easily accommodate growing demands on the network.

### SUMMARY OF THE INVENTION

The present invention overcomes the aforementioned deficiencies in the prior art by providing a peer-to-peer architecture for sharing video on demand content. Instead of requiring a large server to store content such as content server 110 in a typical VOD system 100, VOD content is instead distributed among a plurality of content devices. Intelligent agents are then utilized as a means to seek out VOD content resident on the network of content devices.

Upon receiving a request to view requested content, an intelligent agent determines which content device contains the requested content. In addition to locating content, an intelligent agent is utilized as a means to update a content playlist containing the titles and location of all available VOD content. The intelligent agents may also dynamically update the playlist on the various content devices to remove unavailable titles and to program any desired filters.

In operation, after a content device issues a request for particular VOD content (hereinafter referred to as the “requesting content device” issuing a “content access request”), an intelligent agent locates the requested content on a content device (hereinafter referred to as the “source content device”). The location information for the source content device is communicated by an intelligent agent to the requesting content device. The requesting content device then establishes a VOD session with the source content device.

By alleviating the need for a large content server for storing all of the available VOD content, the present invention results in a less expensive VOD system than the typical VOD system 100 as illustrated in FIG. 1. The present invention also alleviates the need for the extensive maintenance associated with a VOD server. Furthermore, because the VOD content is stored in the content devices, rather than in a VOD server, storage capacity easily increases as the number of content devices increases, resulting in a more flexible network.

### BRIEF DESCRIPTION OF THE DRAWINGS

For a fuller understanding of the present invention, reference is made to the following description taken in connection with the accompanying drawings, in which:

FIG. 1 is a block diagram illustrating a typical VOD system.

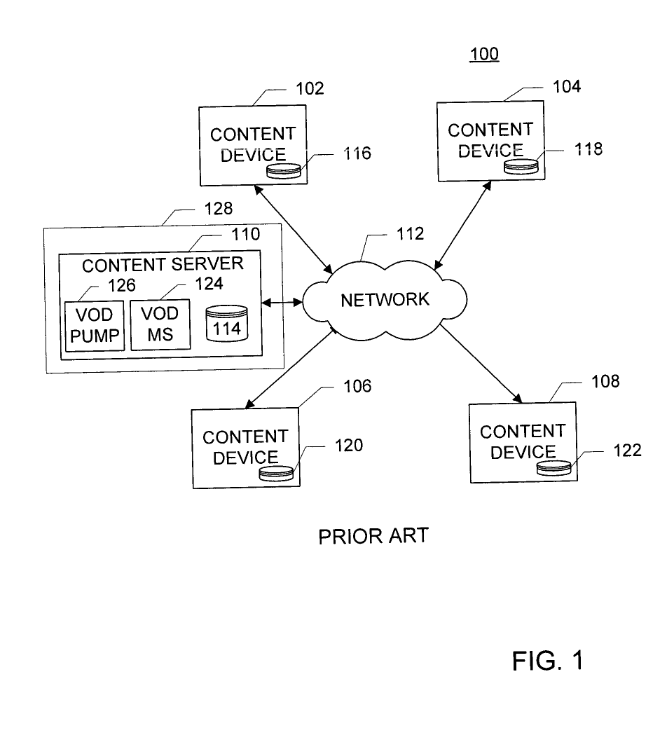

FIG. 2 is block diagram illustrating an exemplary environment for the present invention.

FIG. 3 is a flow diagram illustrating the processing of a content access request in accordance with the present invention.

FIG. 4 depicts an exemplary user interface for displaying the VOD content playlist of the present invention.

### DETAILED DESCRIPTION

The ensuing detailed description provides preferred exemplary embodiments only, and is not intended to limit the scope, applicability, or configuration of the invention. Rather, the ensuing detailed description of the preferred exemplary embodiments will provide those skilled in the art with an enabling description for implementing a preferred embodiment of the invention.

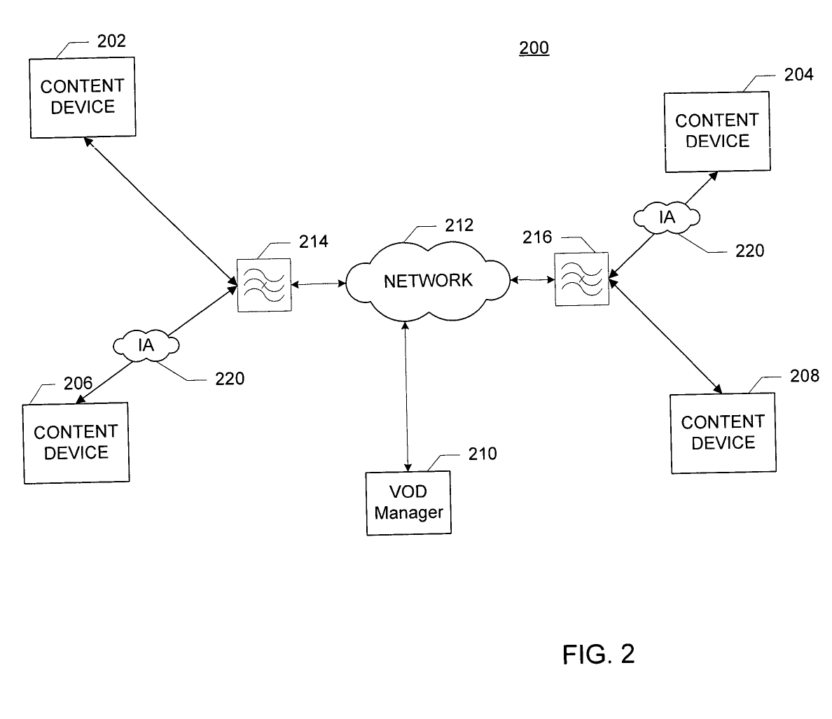

FIG. 2 is block diagram illustrating an exemplary environment for the present invention. Exemplary environment 200 comprises one or more content devices, 202-208. In the exemplary embodiment, these content devices 202-208 comprise personal video recorder (PVR) devices. However, content devices 202-208 may comprise any device capable of storing and presenting content. Furthermore, those skilled in the art will comprehend that the number of content devices in the exemplary embodiment is not limited to four content devices as shown in exemplary environment 200, but may be any number of content devices. Furthermore, for purposes of illustration, in FIG. 2 content device 206 is the requesting content device, and content device 204 is the source content device.

The VOD Manager 210 is also connected to network 212, and provides new VOD content to the content devices 202-208 located throughout the network 212. The VOD Manager 210 accomplishes this task by utilizing the intelligent agents 220 to locate content devices 202-208 with sufficient storage space to store new VOD programs. After discovering a content device 202-208 with sufficient storage space, the VOD Manager 210 uploads the VOD content to the content device with sufficient storage space. This upload process may be, but is not limited to, a trickle method, wherein small portions of the VOD content are uploaded over an extended period of time. Another possibility is a high bandwidth push model, wherein large portions of the VOD content are uploaded over a short period of time. Other alternative methods for the upload process may be, but is not limited to, a data carousel method, an IP method, or a variety of other well-known data transfer methods.

The exemplary environment 200 may also comprise active filters 214-216, which filter radio frequencies for communicating VOD content between content devices 202-208 from propagating to the entire network 212. The intelligent agent 220 programs the filters 214-216 to filter out the frequencies utilized to communicate VOD content between content devices 202-208.

For example, referring to FIG. 2, content device 202 provides VOD content to content device 206, possibly on a unique frequency. Because content devices 204 and 208 are not on the same subsystem as 202 and 206, and thus, do not require access to the VOD content, the frequency may be filtered out of that subsystem by the active filter 214. This filtering process renders the frequency available for a VOD session on the other subsystem.

In an IP-based embodiment, filters 214-216 may comprise routers to manage IP traffic. In this IP-based embodiment, the intelligent agent ensures that the router properly routes and/or filters the packets appropriately. Each content device 202-208 is positioned in a specific location, such as a user's home or office, and communicates with the other content devices in environment 200 over network 212.

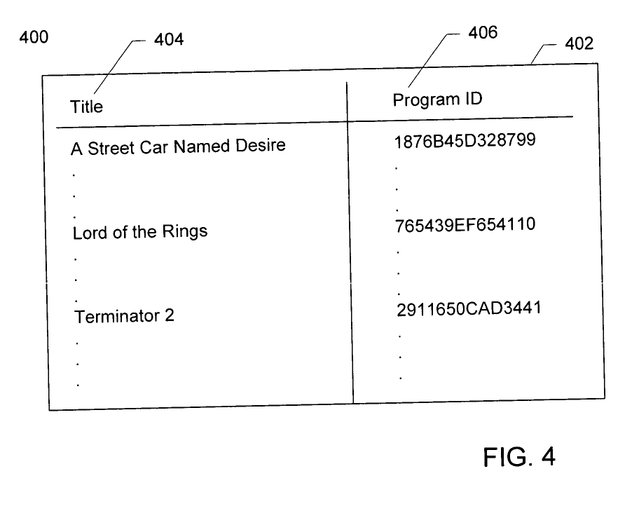

Each content device 202-208 builds a VOD content playlist, described in further detail in FIG. 4, of all available VOD content. In order to build the VOD content playlist, the intelligent agent 220 acquires the titles of all available VOD content on the network. This information is communicated to each content device 202-208, which in turn builds the VOD content playlist.

Once a content access request is received, this VOD content playlist is used to program the intelligent agent 220 to search for the physical location of the requested VOD content. The content device 202-208 determines the location of a particular VOD title by programming the intelligent agent 220 and placing the intelligent agent 220 on the network 212. This process dynamically updates the VOD content playlist, without the need for central storage or a managing device, such as the VOD content server 128 in the prior art. Instead, the VOD content playlist is updated and maintained by the entire network 200.

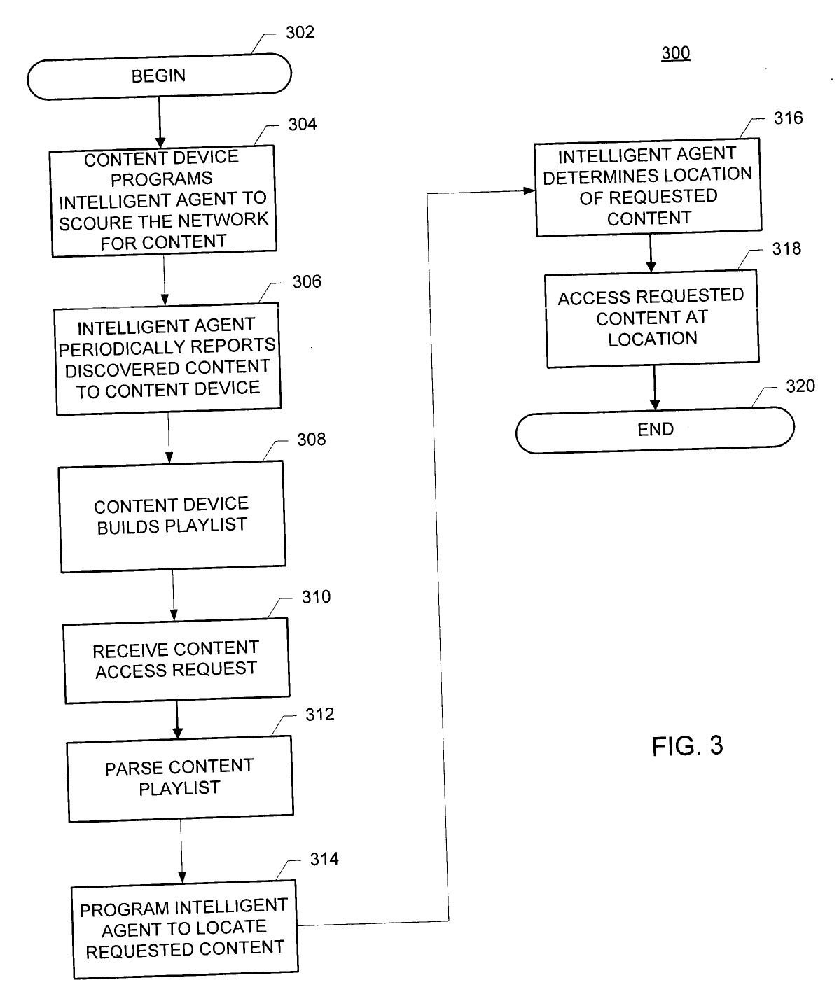

FIG. 3 is a flow diagram illustrating the processing of a content access request in accordance with the present invention. Method 300 begins at step 302 and proceeds to each content device 202-208 programming an intelligent agent to search the network 200 for VOD content at step 304. This step 304 involves the intelligent agent 220 gathering information about the availability of VOD content and reporting this information back to each content device 202-208 at step 306.

At step 308, each content device 202-208 parses the information from intelligent agent and builds a VOD content playlist 402 at step 308. Preferably, the VOD content playlist comprises a list of all of the available VOD content titles on the network, along with a program identifier. However, the VOD content playlist may comprise any other information necessary in accurately reporting the available content to each content device 202-208.

Once a content access request is received at step 310 from a requesting content device 206, the VOD content playlist 402 is parsed at step 312 to ascertain that the requested VOD content is indeed available on the network 200. Next, at step 314, the intelligent agent queries the network for one or more content devices containing the requested content. Once the intelligent agent locates a source content device 204 that contains the requested content, the location information of source content device 204 is reported to the requesting content device 206. The requesting content device 206 then initiates a connection with the source content device 204 containing the content at step 316. Method 300 concludes at step 318.

FIG. 4 depicts the VOD content playlist of the present invention. Each content device 202-208 builds a VOD content playlist 400 of all available VOD content. In order to build the VOD content playlist 400, the intelligent agent 220 acquires the titles of all available VOD content on the network. This information is communicated to each content device 202-208, which in turn builds the VOD content playlist 400.

The VOD content playlist 400 includes the title 404 of the VOD content and a program identifier 406 associated with the title 404. Each program identifier 406 associated with each title 404 is unique when compared with the program identifier 406 associated with every other title 404 available in the system. The program identifier 406 consists of an alpha/numeric string of sufficient length to ensure the uniqueness of the system for a large number of titles. The program identifier 406 is utilized by the requesting content device when programming the intelligent agent to query the network for requested content.

Although the invention has been described in connection with various illustrated embodiments, numerous modifications and adaptations may be made thereto without departing from the spirit and scope of the invention as set forth in the claims.

1. A method of accessing requested content on a source content device connected to a network, said method comprising the steps of:
issuing a content access request identifying requested content;
determining the location of the source content device including the requested content in the network; and
accessing the requested content at the source content device.

2. The method of claim 1, wherein issuing a content access request identifying requested content comprises issuing a content access request including a program identifier.

3. The method of claim 1, wherein issuing a content access request identifying requested content comprises issuing a content access request including the title of the requested content.

4. The method of claim 1, wherein determining the location of the source content device including the requested content in the network comprises engaging an intelligent agent to determine the location of the source content device.

5. The method of claim 1, wherein determining the location of the source content device including the requested content in the network comprises examining the results from the intelligent agent for the information concerning the location of the source content device.

6. The method of claim 1, wherein accessing the requested content at the source content device comprises accessing the content at the source content device across the network.

7. A method of storing content on a content device for access by a network including one or more content devices, said method comprising the steps of:
receiving content for access by the network;
querying one or more content devices to ascertain storage capacity;
determining the content device with the optimum storage capacity; and
uploading the content to the content device with the optimum storage capacity.

8. The method of claim 7, wherein determining the content device with the optimum storage capacity comprises determining the content device with the largest amount of storage capacity.

9. The method of claim 7, wherein uploading the content to the content device with the optimum storage capacity comprises utilizing a trickle method.

10. The method of claim 7, wherein uploading the content to the content device with the optimum storage capacity comprises utilizing a high bandwidth push model.

11. The method of claim 7, wherein uploading the content to the content device with the optimum storage capacity comprises utilizing a data carousel method.

12. The method of claim 7, wherein uploading the content to the content device with the optimum storage capacity comprises utilizing an internet protocol method.
